(19) United States
(12) Patent Application Publication
(10) Pub. No.: US 2015/0098092 A1
(43) Pub. Date: Apr. 9, 2015

(54) Device and Method For the Simultaneous Three-Dimensional Measurement of Surfaces With Several Wavelengths

(71) Applicant: AiMESS Services GmbH, Burg (DE)

(72) Inventor: Ernst Wiedenmann, Aalen (DE)

(73) Assignee: AiMESS Services GmbH, Burg (DE)

(21) Appl. No.: 14/249,849

(22) Filed: Apr. 10, 2014

(30) Foreign Application Priority Data
Apr. 30, 2013 (EP) 13 165 992.2

(51) Int. Cl. G01B 11/25

(52) U.S. Cl. CPC G01B 11/25
USPC 356/603

(57) ABSTRACT

The invention relates to an apparatus for the three-dimensional measurement of an object, and comprises a projection system for projecting a pattern onto a surface by means of electromagnetic radiation having at least two different wavelengths or at least two different wavelength ranges; and a detector system for detecting the projected pattern at the at least two different wavelengths or at at least two different respective wavelengths from the at least two different wavelength ranges. The invention further relates to a method for the three-dimensional measurement of an object.

### FIELD OF THE INVENTION

The invention relates to a device and a method for the three-dimensional measurement of objects by means of a topometrical method.

### PRIOR ART

The three-dimensional measurement of object surfaces by means of optical triangulation sensors according to the topometry principle is adequately known. For example, different stripe patterns are projected onto the object to be measured, are observed by one or more cameras, and are subsequently evaluated by a computer. The evaluation methods are, for example, the phase shift method, the coded light approach or the heterodyne method.

The projector projects, sequentially in time, patterns of parallel light and dark stripes, of identical or different width, onto the object of measurement. Moreover, methods involving random patterns are used. The projected stripe pattern is deformed subject to the shape of the object and the viewing direction. The camera, respectively, cameras register the projected stripe pattern at a known viewing angle relative to the projection direction. Each camera takes an image for each projection pattern. For the evaluation of the measurements, for example, the boundary line (the edge) between a light and a dark stripe is relevant. With random patterns the evaluation is made on the basis of the projected surfaces, and in phase shift methods the intensity distribution is evaluated.

To allow the measurement of the whole object the pattern is moved across the object (scanning). Thus, a time sequence of different brightness values is created for each image point of all cameras. The image coordinates for a given object point are known in the camera image. The number of the stripe can be calculated from the sequence of brightness values that were measured from the image sequence for each camera image point. In the simplest case this is accomplished by a binary code (e.g. a Gray code) which distinguishes the number of the stripe as a discrete coordinate in the projector.

A greater accuracy can be achieved with the so-called phase shift method which is capable of determining a non-discrete coordinate. The phase position of a modulated signal is determined by point-by-point intensity measurements. The phase position of the signal is shifted at least twice by a known value, while the intensity is measured at one point. The phase position can be calculated from three or more measured values. The phase shift method can be used either to supplement a Gray code, or as an absolute measuring heterodyne method (with several wavelengths).

The bases and practical applications of such topometrical measuring methods are described in detail, for example, in Bernd Breuckmann: “Bildverarbeitung and optische Messtechnik in der industriellen Praxis”, 1993, Franzis-Verlag GmbH, Munich.

In most cases, however, technically relevant objects consist of several surfaces. The applied measuring methods should cover the total surface with a comparable quality. Depending on the wavelength and method there are surfaces that are cooperative, and surfaces that are not cooperative so that it is consequently impossible to achieve a uniform quality for the whole object, respectively, the measurement is uncertain.

### DESCRIPTION OF THE INVENTION

Given the disadvantages of the prior art, the invention is based on the problem to overcome these disadvantages. By the present invention a method is described, and an apparatus is depicted, which create cooperative conditions for the different surfaces by making use of several wavelengths.

The mentioned problem is solved by the apparatus according to claim 1 and by the method according to claim 9.

The apparatus according to the invention for the three-dimensional measurement of an object comprises a projection system for projecting a pattern onto a surface by means of electromagnetic radiation having at least two different wavelengths or at least two different wavelength ranges; and a detector system for detecting the projected pattern at the at least two different wavelengths or at at least two different respective wavelengths from the at least two different wavelength ranges. Examples for advantageously applied wavelength ranges is ultraviolet light (UV), visible and/or infrared (IR) light. The simultaneous use of light having at least two different wavelengths or wavelength ranges allows the detection of materials that are, for example, not cooperative for one of the wavelengths used by means of the other wavelength. Cooperative implies in this connection that if the heat pattern applied to the surface by projection is absorbed, a substantial portion of the impinging radiation is absorbed so as to be radiated again as heat radiation. As opposed to this the meaning of cooperative, in the case of reflection measurements, is that a great portion of the impinging radiation is reflected diffusely without being absorbed. The use of at least two different wavelengths or at least two different wavelength ranges furthermore brings about a good separation of the radiation detected by the detector system for the simultaneous detection of the projected pattern according to wavelengths. As required, two, three, four or five, or even more than five different wavelengths or wavelength ranges may be used. In the case of a simultaneous use of light having at least two different wavelength ranges these ranges do preferably not overlap, but are entirely different/separate from each other, so as to obtain a complete separation of the surface information with regard to the two different wavelengths.

According to an embodiment of the apparatus according to the invention the detector system may be configured for the simultaneous or for the sequential detection of the projected pattern at the at least two different wavelengths or at at least two different respective wavelengths from the at least two different wavelength ranges.

According to a further development of the apparatus according to the invention the projection system may comprise at least two radiation sources for generating the radiation at the at least two different wavelengths or at at least two different wavelength ranges, in particular at least two lasers having a different radiation wavelength. Thus, it is possible to generate the radiation with the respective wavelength independently of the other one, so that the position thereof is independently determinable. Also, for example, no lossy color filters have to be used. If laser light sources are used high radiation intensities are obtained at the respective wavelength. Advantageous examples for the radiation sources are, in this context, laser light sources, but any other light sources are usable as well, such as LEDs, deuterium discharge lamps, high-pressure and extra high-pressure gas discharge lamps.

According to another further development the projection system may comprise a wavelength combiner and/or a beam guiding optical system and/or means for moving the projected pattern relative to the surface. A wavelength combiner allows the generation of a light beam which contains the shares of the at least two radiations sources (with two or more colors), which can then be passed on in the beam guiding optical system. The light beam can then be directed, for example, to a mask having the pattern to be projected (e.g. a stripe pattern). The means for moving the projected pattern relative to the surface moves the pattern across the object, respectively, surface of the object to be detected (scanning) so as to sweep over different regions of the surface.

According to another further development the at least two radiation sources may comprise respective adjusting elements for individually adjusting the respective radiation intensity. This further development allows the adaptation of the radiation intensities to the respective material conditions, for example, in order to achieve a brightness distribution as homogeneous as possible of the radiation backscattered from the surface at the different wavelengths if the object is formed of different materials.

According to another further development the detector system comprises a camera or a group of cameras for each wavelength or each wavelength range, wherein, if a group of cameras is provided, in particular different detection directions with respect to the surface are respectively provided. Thus, the different wavelengths can be detected independently of each other, and the sensitivity of each camera can be optimized with respect to the respective wavelength. Furthermore, the use of several cameras for a certain wavelength allows the simultaneous detection of the surface at several triangulation angles.

In one embodiment a camera may be used which is sensitive at different wavelengths, e.g. an RGB camera together with red, green and blue lasers/diodes as radiation sources.

According to another further development the wavelengths or wavelength ranges are in the ultraviolet, optical and/or infrared spectral range. By the extension of the used wavelengths to the infrared range it is also possible to measure, for example, material combinations including glass by means of the triangulation method.

According to another further development the respective pattern is a stripe pattern which is generated in particular by a corresponding mask of transparent and nontransparent sections in the projection system. This constitutes a pattern form that is particularly easy to measure and evaluate. Alternatively, the pattern may also be generated by a DLP chip (Digital Light Processing).

According to another further development the apparatus may further comprise an evaluation device for generating wavelength-selective three-dimensional surface data from the projected pattern detected by the detector system according to the triangulation method and for merging the wavelength-selective data; or an evaluation device for merging wavelength-selective data from the projected pattern detected by the detector system and for generating three-dimensional surface data according to the triangulation method. Depending on the alternative used, thus, wavelength-selective three-dimensional surface data are generated first, which are then merged or, vice versa, the wavelength-selective data are merged first, and then the three-dimensional surface data are generated.

The aforementioned problem is further solved by the method according to the invention for the three-dimensional detection of a surface, comprising the steps of: projecting a pattern onto a surface by means of electromagnetic radiation having at least two different wavelengths or at least two different wavelength ranges; and simultaneously detecting the projected pattern at the at least two different wavelengths or at at least two different respective wavelengths from the at least two different wavelength ranges. The advantages of the apparatus according to the invention and the further developments thereof apply correspondingly to the method and to the further developments described below.

According to a further development of the method according to the invention the further step of projecting the pattern can be performed by at least two radiation sources for generating the radiation at the at least two different wavelengths or at least two different wavelength ranges, in particular by at least two lasers having a different radiation wavelength. As was already explained above, other radiation sources can be advantageously used as well.

Another further development is that the further step of combining the radiation having different wavelengths and/or guiding the radiation and/or moving the projected pattern relative to the surface is carried out.

According to another further development the method comprises the further step of individually adjusting the respective radiation intensity of the at least two radiation sources.

According to another further development the respective pattern may be a stripe pattern which is generated in particular by a corresponding mask of transparent and nontransparent sections in the projection system.

Another further development comprises the further step of generating wavelength-selective three-dimensional surface data from the projected pattern detected by the detector system according to the triangulation method and merging the wavelength-selective data; or of merging wavelength-selective data from the projected pattern detected by the detector system and generating three-dimensional surface data can be carried out according to the triangulation method.

The various further developments can be applied independently of each other, or can be combined with each other.

Additional preferred embodiments of the invention will be described below with reference to the drawings.

### BRIEF DESCRIPTION OF THE DRAWINGS

FIG. 1 shows a first embodiment of the apparatus according to the invention.

FIG. 2 shows a second embodiment of the apparatus according to the invention.

FIG. 3 illustrates the method according to the invention in connection with the apparatus according to the invention.

### DESCRIPTION OF THE EMBODIMENTS

By the present invention a method is described and an apparatus is depicted which create cooperative conditions for the different surfaces by making use of several wavelengths.

The invention relates to a method and a device for the 3D detection of surfaces by means of a surface-measuring optical method. A structured lighting with several wavelengths is generated simultaneously and detected wavelength-selectively at a triangulation angle.

FIG. 1 shows a first embodiment of the apparatus according to the invention.

The apparatus 100 for the three-dimensional measurement of a surface 110 comprises a projection system 120 for projecting a pattern 140 onto the surface 110 by means of electromagnetic radiation. The radiation in this embodiment is generated, for example, by two lamps 121, 122. Lamp 121 radiates radiation in a first wavelength range, and lamp 122 radiates radiation in a second wavelength range. The first and the second wavelength ranges are different from each other. Preferably, the ranges are entirely separated/separate. Furthermore, a detector system 130 is provided for the simultaneous detection of the projected pattern 140 at two different respective wavelengths from the at least two different wavelength ranges.

For example, the first lamp 121 may radiate in the red spectral range, and the second lamp 122 may radiate in the blue spectral range. The lamps may comprise, for example, LEDs with the corresponding radiation wavelengths, respectively, radiation wavelength range. The detector system 130 in this embodiment consists, for example, of a digital camera with a sensor chip that is sensitive for the two different wavelengths/wavelength ranges. For example, the sensor chip may be a so-called Bayer sensor having a Bayer pattern and, thus, being able to separately detect in particular red and blue light with the respective color-filtered pixels.

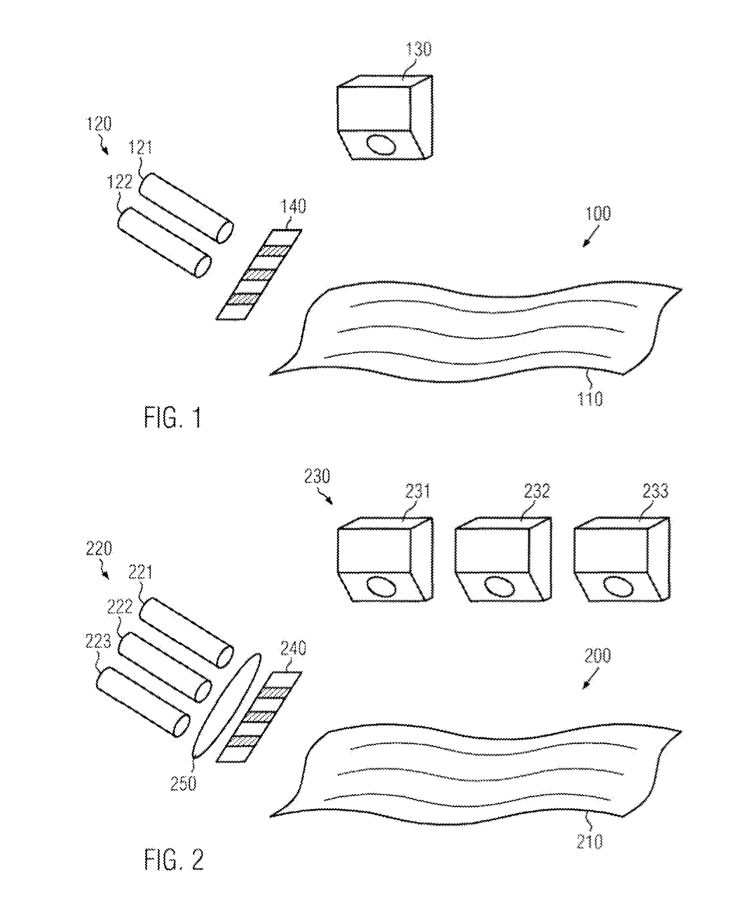

FIG. 2 shows a second embodiment of the apparatus according to the invention for the three-dimensional detection of a surface. Corresponding reference numbers in FIG. 1 and FIG. 2 denote like elements. Merely the hundreds digit is increased from 1 to 2.

As opposed to the first embodiment according to FIG. 1 the second embodiment includes a third light source 223 which radiates light having a third wavelength that is different from the first and the second wavelengths. The light sources can be, for example, lasers with three different radiation wavelengths. The apparatus further comprises a beam guiding optical system 250 which directs the light from the different light sources combined onto the pattern 240. Also, three cameras 231, 232, 233 are provided in this embodiment, each being sensitive for one of the three radiated wavelengths.

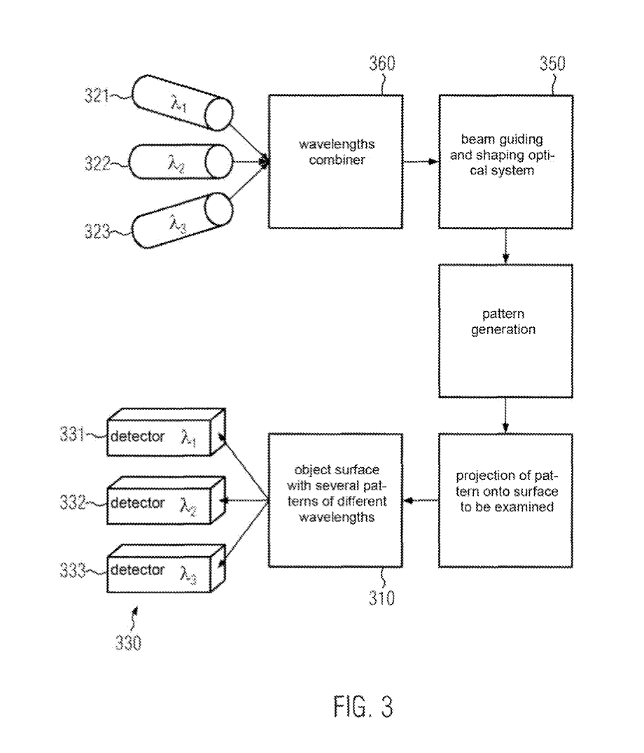

FIG. 3 illustrates the method according to the invention in connection with the apparatus according to the invention. Corresponding reference numbers denote like elements. Merely the hundreds digit is increased to 3.

The radiation sources 321, 322, 323 generate radiation each of a different wavelength. In the wavelengths combiner 360 these wavelengths are combined to one radiation bundle. The beam guiding and beam shaping optical system guides the radiation bundle onto the pattern to be projected (respectively, the mask having the pattern). There, the projected pattern with the three different wavelengths is generated and directed to the surface of the three-dimensional object to be detected. The projected pattern of different wavelengths is scattered by the surface and detected by detectors 331, 332, 333, each being sensitive for the respective wavelength. Based on the detected data wavelength-selective three-dimensional surface data are then generated from the projected pattern detected by the detector system according to the triangulation method and the wavelength-selective data are merged.

Alternatively, it is possible to merge wavelength-selective data from the projected pattern detected by the detector first, and generate three-dimensional surface data according to the triangulation method subsequently.

In particular, the beam guiding optical system may also comprise means for moving the pattern across the surface, allowing a scanning to be carried through.

Summarizing, the entire system may include the following features. The detector for a respective wavelength may be a single camera or a group of cameras two or more). The 3D determination is realized by triangulation. The point detection with respect to the different wavelengths is carried out simultaneously. Thus, it is possible to overcome the disadvantages of the individual wavelengths. A system calibration is carried out simultaneously as well. A simultaneous scanning effects identical conditions and, thus, a simple fusion of data. The simultaneous detection yields in significant time benefits. An automatic matching (registering) of different view is clearly simplified as features are easier to identify at different wavelengths. If the pattern is moved across the surface the detection of the patterns with respect to the changed projection areas is, of course, consecutive in terms of time.

1. Apparatus for the three-dimensional detection of a surface, comprising:
a projection system for projecting a pattern onto a surface by means of electromagnetic radiation having at least two different wavelengths or at least two different, preferably separate, wavelength ranges; and
a detector system for detecting the projected pattern at the at least two different wavelength or at at least two different respective wavelengths from the at least two different wavelength ranges.

2. Apparatus according to claim 1, wherein the projection system comprises at least two radiation sources for generating the radiation at the at least two different wavelengths or at least two different wavelength ranges, in particular at least two lasers having a different radiation wavelength.

3. Apparatus according to claim 1, wherein the projection system comprises a wavelength combiner and/or a beam guiding optical system and/or means for moving the projected pattern relative to the surface.

4. Apparatus according to claim 2, wherein the at least two radiation sources comprise respective adjusting elements for individually adjusting the respective radiation intensity.

5. Apparatus according to claim 1, wherein the detector system comprises a camera or a group of cameras for each wavelength or each wavelength range, wherein, if a group of cameras is provided, in particular different detection directions with respect to the surface are respectively provided.

6. Apparatus according to claim 1, wherein the wavelengths or wavelength ranges are in the ultraviolet, optical and/or infrared spectral range.

7. Apparatus according to claim 1, wherein the respective pattern is a stripe pattern which is generated in particular by a corresponding mask of transparent and nontransparent sections in the projection system.

8. Apparatus according to claim 1, further comprising:
an evaluation device for generating wavelength-selective three-dimensional surface data from the projected pattern detected by the detector system according to the triangulation method and for merging the wavelength-selective data; or
an evaluation device for merging wavelength-selective data from the projected pattern detected by the detector system and for generating three-dimensional surface data according to the triangulation method.

9. Apparatus according to claim 1, wherein the detector system is configured for the simultaneous or for the sequential detection of the projected pattern at the at least two different wavelengths or at least two different respective wavelengths from the at least two different wavelength ranges.

10. Method or the three-dimensional detection of a surface, comprising the steps of:
projecting a pattern onto a surface by means of electromagnetic radiation having at least two different wavelengths or at least two different wavelength ranges;
simultaneously detecting the projected pattern at the at least two different wavelengths or at at least two different respective wavelengths from the at least two different wavelength ranges.

11. Method according to claim 10 comprising the further step of:
projecting the pattern by at least two radiation sources for generating the radiation at the at least two different wavelengths or at least two different wavelength ranges, in particular by at least two lasers having a different radiation wavelength.

12. Method according to claim 10, comprising the further step of:
combining the radiation having different wavelengths and/or guiding the radiation and/or moving the projected pattern relative to the surface.

13. Method according to claim 10, comprising the further step of:
individually adjusting the respective radiation intensity of the at least two radiation sources.

14. Method according to claim 10, wherein the respective pattern is a stripe pattern which is generated in particular by a corresponding mask of transparent and nontransparent sections in the projection system.

15. Method according to claim 14, comprising the further step of:
generating wavelength-selective three-dimensional surface data from the projected pattern detected by the detector system according to the triangulation method and merging the wavelength-selective data; or
merging wavelength-selective data from the projected pattern detected by the detector system and generating three-dimensional surface data according to the triangulation method.

16. Method according to claim 10, comprising the further step of:
generating wavelength-selective three-dimensional surface data from the projected pattern detected by the detector system according to the triangulation method and merging the wavelength-selective data; or
merging wavelength-selective data from the projected pattern detected by the detector system and generating three-dimensional surface data according to the triangulation method.
